(19) United States
(12) Patent Application Publication
(10) Pub. No.: US 2009/0217280 A1
(43) Pub. Date: Aug. 27, 2009

(54) Shared-Resource Time Partitioning in a Multi-Core System

(75) Inventors: Larry J. Miller, Black Canyon City, AZ (US); James C. Fye, Scottsdale, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/035,062

(22) Filed: Feb. 21, 2008

(51) Int. Cl. G06F 9/46

(52) U.S. Cl. 718/104

(57) ABSTRACT

An improvement to computing systems is introduced that allows a hardware controller to be configured to time partition a shared system resource among multiple processing elements, according to one embodiment. For example, a memory controller may partition shared memory and may include processor-accessible registers for configuring and storing a rate of resource budget replenishment (e.g. size of a repeating arbitration window), a time budget allocated among each entity that shares the resource, and a selection of a hard or soft partitioning policy (i.e. whether to utilize slack bandwidth). An additional feature that may be incorporated in a main-memory-access time-partitioning application is an accounting policy to ensure that cache write-backs prompted by snoop transactions are charged to the data requester rather than to the responder. Additionally, an arbiter may prioritize requests from particular requesting entities.

### FIELD

The embodiments herein relate to a method and system for time-partitioning shared resources in a system with multiple processing units, such as a multi-core system.

### BACKGROUND

As the microprocessor industry continues to improve the performance of central processing units (CPUs), more emphasis is being placed on designs supporting multiple cores on a single chip. The emphasis is due, at least in part, to an increased need for thread-level parallelism. As is well known in the art, multiple applications may execute in parallel on a multi-tasking operating system. Furthermore, each of these applications may be further divided into multiple threads of execution. Each thread may be also referred to as a “process” or “task.” A system with multiple processing elements, or cores, is able to execute more threads concurrently than a system with a single core, and thereby improve system performance.

However, multiples cores in a system, and even multiple threads on those cores, may contend for access to shared resources. For example, memory in computer systems is typically hierarchical, with small amounts of fast memory located nearby the cores in a cache, while a larger amount of slower memory is available in main memory (e.g., RAM) and an even larger amount of yet slower memory is available in secondary storage (e.g., a disk drive). A thread may require memory to hold its instructions and data. Instructions are the actual microprocessor codes that a core will execute on behalf of a thread. The set of all instructions that comprise an executable program is sometimes referred to as the program's “image.” Data is the static and dynamic memory that a thread uses during execution.

Input and output (I/O) resources may also be shared across multiple threads and multiple cores. A system may have a single I/O bus dedicated to receiving input from input devices, such as keyboards, mouses, and joysticks, and to transmitting output to output devices, such as graphical displays, monitors, and printers. The I/O bus may be configured such that it only communicates with a single processing element at a time; therefore, multiple processing elements may contend for access to the I/O bus and the underlying I/O components. Additionally, an I/O bus may communicate directly with a memory unit in a direct memory access (DMA) transaction and may thus contend with other processing elements for memory access.

In real-time computer systems, such as mission-critical avionics command and control systems, critical threads may need to execute a certain number of times within a given time frame. Full-featured real-time operating systems provide time partitioning, allowing a means to specify an execution rate and time budget for each “thread of execution.” The operating system must provide guarantees that each thread will receive its budgeted CPU time each period. Despite CPU time guarantees, the amount of work a thread can accomplish during its period can vary greatly from period to period, especially where cache is utilized. The more liberal the cache policy used, the greater the potential variation in execution time from period to period. In order to deal with such variations, cache can be disabled, or thread budgets can be established in the face of maximum cache interference. Beyond cache effects, other devices, such as DMA controllers, can also vie with the processor for shared memory and I/O resources. This interference also should be taken into account when defining thread budgets.

The resource management issues involved with determining thread budgets on a single processing unit, or single core, are multiplied in a multi-core system. In a multi-core system, each core may be executing multiple threads while sharing system resources, such as an I/O bus and a main memory unit, between cores. Indeed, as a single core may budget its own processing resources among threads, multi-cores may budget shared system recourses across multiple cores. For instance, a multi-core system may have a physically partitioned main memory that allocates particular portions of memory to particular cores. However, because a shared resource like main memory may only be accessible by a single entity at a time, such partitioning may create bottlenecks in the data path.

The interference problem of multiple cores competing for shared resources can be addressed in a number of ways. A multi-core CPU can be hobbled by disabling one or more cores to prevent interference, thus turning a multi-core CPU into a single core CPU. Another option involves setting the budget for each core in the face of maximum interference from the other cores. However, these approaches require excessive over-budgeting to ensure that a core's tasks can be completed. In terms of guaranteed performance (as opposed to typical CPU throughput), this would negate most or all of the benefit of having multiple cores. Other software strategies for partitioning shared resources may operate on an honor system where threads and core police themselves, and these schemes may be inefficient due to the processing time cost of implementation and due to misbehaved programs that ignore their quotas.

### SUMMARY

An improvement to computing systems is introduced that allows a hardware controller to be configured to partition shared system resources among multiple processing units, according to one embodiment. For example, the controller may partition memory and may include processor accessible registers for configuring and storing a rate of resource budget replenishment (e.g. size of a repeating arbitration window), a time budget allocated among each entity that shares the resource, and a selection of a hard or soft partitioning policy (i.e. whether to utilize slack bandwidth). An additional feature that may be incorporated in a main-memory-access time partitioning application is an accounting policy to ensure that cache write-backs prompted by snoop transactions are charged to the data requester rather than to the responder. Additionally, an arbiter may prioritize requests from particular requesting entities.

### BRIEF DESCRIPTION OF THE DRAWINGS

FIG. 1 is a block diagram illustrating a system for time-partitioning access to a shared resource, such as a main memory, according to an embodiment of the invention.

FIG. 2 is a block diagram illustrating access flows between the entities shown in the system of FIG. 1, according to one embodiment of the invention.

FIG. 3 is a block diagram illustrating the arbiter 110 in further detail, according to one embodiment of the invention.

### DETAILED DESCRIPTION

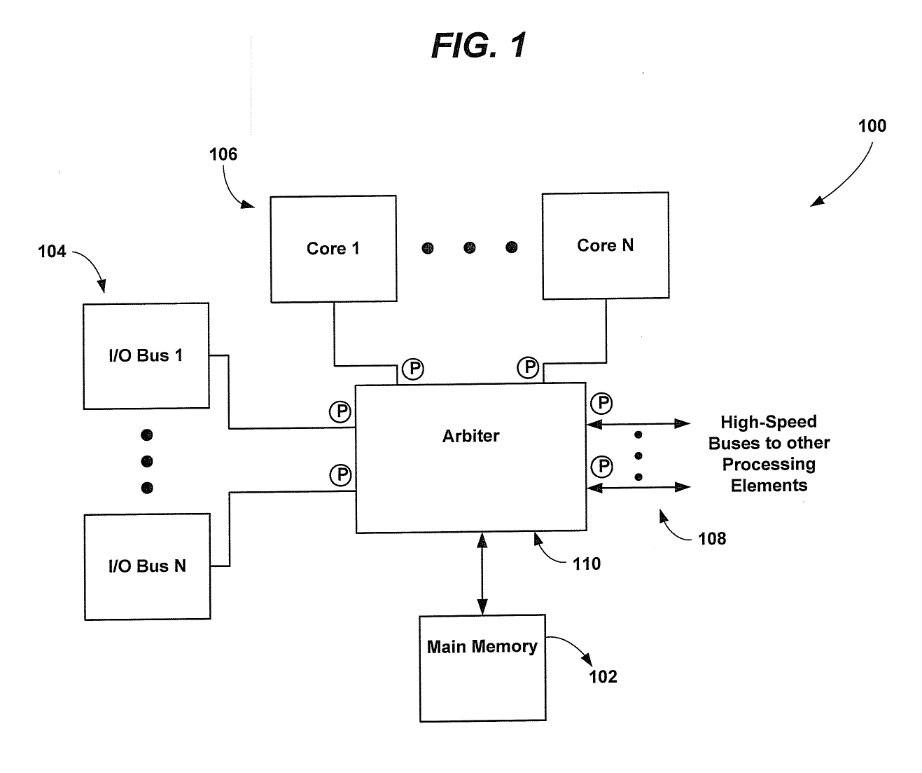

FIG. 1 is a block diagram illustrating a system 100 for time-partitioning access to a shared resource, such as a main memory 102 and I/O buses 104. Other shared resources can also be allocated according to the concepts disclosed herein. The system 100 is directed to providing one or more cores, or processing elements, 106 in a multi-core CPU with access to main memory 102 and I/O buses 104. The I/O buses 104 provide access to one or more I/O resources (not shown) and may themselves access main memory 102, for example during a DMA transaction. In addition, high-speed buses 108 to other processing elements (not shown) may allow the other processing elements (which may be, for example, single-core, multi-core, or graphics processors) to access the shared resources. An arbiter 110 regulates access between processing units, memory devices, and I/O ports and may be implemented in centralized or distributed form. In a preferred embodiment, the arbiter 110 is part of a memory or I/O controller integrated into a microprocessor package. The example of FIG. 1 pertains to partitioning memory access; therefore, the arbiter 110 has a series of ports P—one for each potential path to the main memory 102 from the view of the arbiter 110.

It should be understood, however, that this and other arrangements and processes described herein are set forth for purposes of example only, and other arrangements and elements (e.g., machines, interfaces, functions, and orders of elements) can be added or used instead and some elements may be omitted altogether. Further, as in most computer architectures, those skilled in the art will appreciate that many of the elements described herein are functional entities that may be implemented as discrete components or in conjunction with other components, in any suitable combination and location. For example, a system may contain multiple independent main memories and secondary storages, not shown in FIG. 1. Each unit of memory in system 100 may comprise semiconductor memory, magnetic memory, optical memory, acoustic memory, biological memory, or any combination of these memory technologies, or any other memory technology used in conjunction with computational devices.

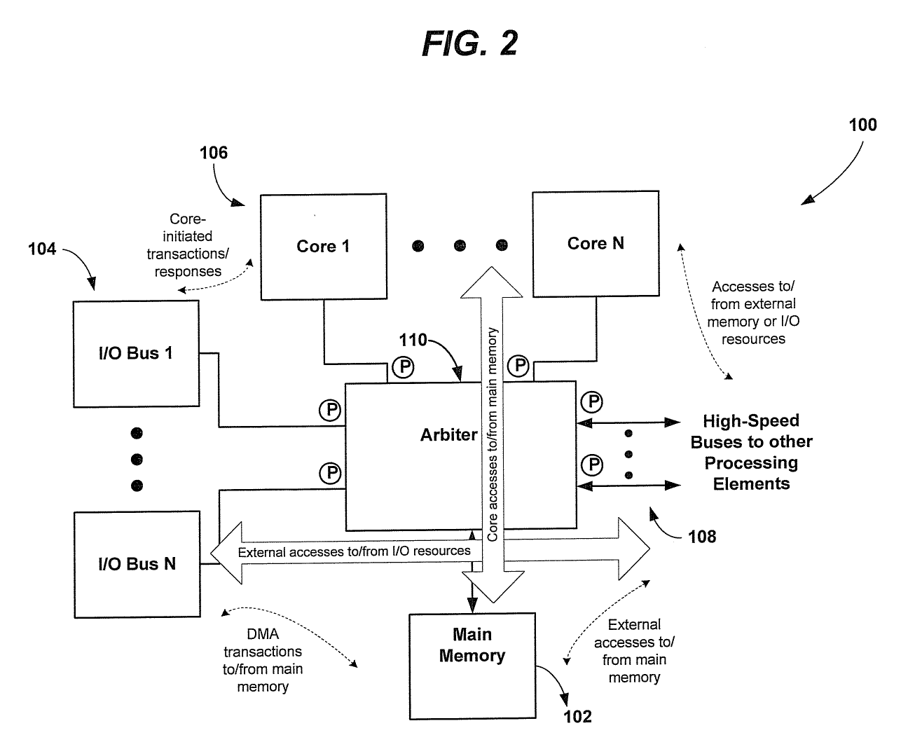

FIG. 2 is a block diagram illustrating access flows between the entities shown in the system 100 of FIG. 1. Each of the following flows passes through a port P of the arbiter 110 and is thus subject to arbitration.

The arbiter 110 may arbitrate any transactions between requesting entities in the system and a shared resource. For example, arbitrer 110 may control core-initiated transactions and responses with I/O buses 104, core accesses to and from the main memory 102, and core accesses to and from external memory or I/O resources through the high-speed buses 108, and external accesses by other processing elements (perhaps through high-speed buses 108) to and from the main memory 102. Main memory 102 may be physically separate banks of memory with interleaved addressing, such that main memory 102 appears to cores and processing elements to be a single unit, though arbiter 110 may communicate directly with the separate banks of main memory 102, as dictated by a requested address. In addition, transactions such as DMA transactions may involve the I/O buses 104 directly accessing the main memory 102, and in that situation, the I/O buses 104 would be processing units or requesting entities from the perspective of arbiter 110. Further, the arbiter 110 may arbitrate external accesses (such as by other processing elements through high-speed buses 108) to and from I/O buses 104.

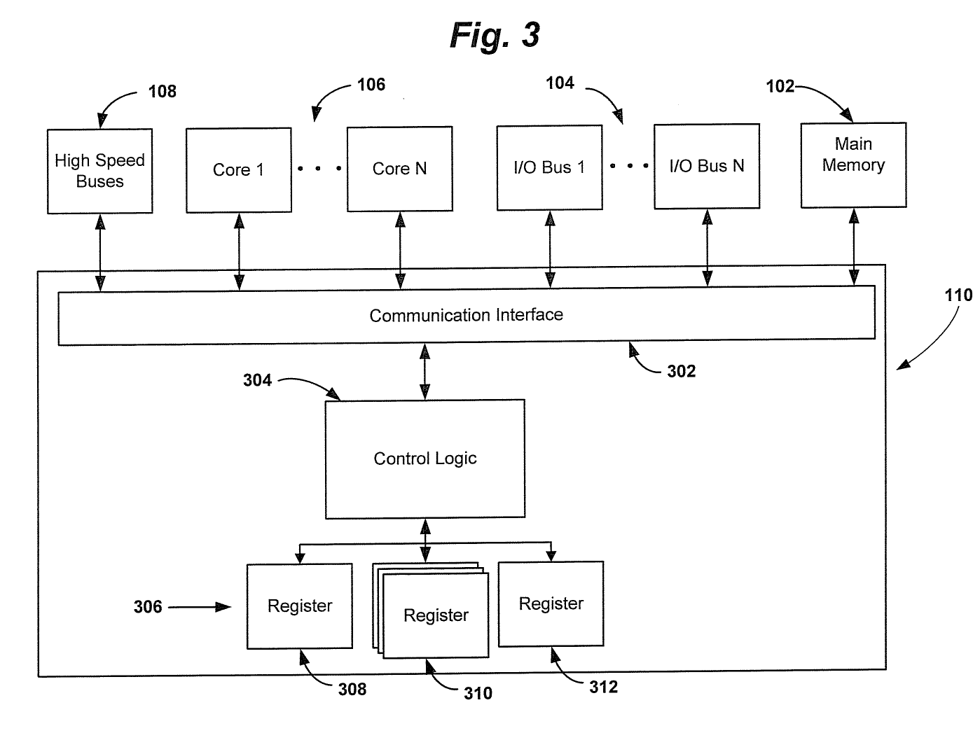

FIG. 3 is a block diagram illustrating the arbiter 110 in further detail, according to one embodiment of the invention. Arbiter 110 contains communication interface 302, control logic 304, and registers 306. All interactions between cores 106, high speed buses 108, and system resources such as I/O buses 104 and main memory 102 preferably flow through arbiter 110, and arbiter 110 sends and receives communications through communication interface 302. Control logic 304 implements an arbitration scheme by managing the communications through communication interface 302 and by writing to and reading from registers 306.

Registers 306 may store the values of various parameters of a time-partitioning scheme. First, Rate of Resource Budget Replenishment Register 308 may store the value of the time window that is partitioned, which would correspond to the time between resets of the arbitration window. Second, an array 310 of Resource Budget Registers that store the time budget for each entity that accesses the shared resource. Third, Partitioning Toggle Register 312 that chooses between a hard partitioning scheme and a soft partitioning scheme.

Rate of Resource Budget Replenishment Register 308 stores the size of a repeating arbitration window. This window is the amount of time over which one cycle of arbitration would occur, and that value might be defined in units of time or in clock cycles. One instance of the arbitration window may be referred to as an iteration, and once one iteration of the arbitration window has elapsed, the next iteration of the arbitration window may begin. Resource Budget Registers 310, in turn, store the time budget, within a single arbitration window, allocated to each entity that shared the resource, and these budgets may be defined in terms of percentages, time, or clock cycles. The total allocated budget-the sum of all the values in the Resource Budget Registers—may be equal to or less than the total budget available (either 100% or the amount of time or the number of clock cycles defined as the arbitration window), but it may not be greater than the total budget available.

As an example, arbiter 110 may be partitioning main memory 102 between two cores 106. The arbitration window may be defined as 100 clock cycles and stored in Rate of Resource Budget Replenishment Register 308. The two entities may be two cores, Core 1 and Core 2, and each core may have a budget of 50%, and those percentages may be stored in the Resource Budget Registers 310 respectively associated with Core 1 and Core 2. Therefore, out of every 100 clock cycles, Core 1 may use 50 clock cycles to access the shared resource through the arbiter, and Core 2 may, in turn, use the other 50 clock cycles to access the shared resource through the arbiter, and accesses by the two cores may be interleaved. However, once Core 1 uses 50 clock cycles of a particular arbitration window, it has exhausted its budget for that arbitration window, and it must wait for the window to reset (for the 100 clock cycles to elapse) before it may again access the shared resource.

With equal time budgeted to each core, arbiter 110 may show equal preference to requests from either core. In an alternate embodiment, if Core 1 were given a budget of 75%, and Core 2 were given a budget of 25%, the arbiter may not only give Core 1 75 clock cycles of each 100 clock cycles to access the shared resource but may also prefer requests from Core 1 at a ratio of 3:1 to requests from Core 2. For example, at the beginning of an arbitration window, when neither core has exhausted its budget, Core 2 may wait for three accesses of main memory 102 by Core 1 before arbiter 110 allows Core 2 a single access, assuming the accesses require equal amounts of time to complete. In another alternate embodiment, the preference shown to each core may be different from the budget for each core. For example, Core 1 may have a budget of 75% to Core 2's 25% budget, but requests from Core 2 may be preferred 3:1 to requests from Core 1, though this may result in Core 2 exhausting its budget very quickly in any given arbitration window. In the embodiments calling for anything other than a lack of preference between requesting entities, the relative preferences of entities may be stored in the Resource Budget Registers or may be stored separately in Priority Registers.

Partitioning Toggle Registers 312 may set the partitioning scheme to either hard or soft partitioning. In the hard partitioning setting, the set budgets in Resource Budget Registers 310 would be strict budgets for each entity in each arbitration window, regardless of whether those budgets were being used. In the soft partitioning setting, arbiter 110 may take into account the behavior of the budgeted entities to reallocate time with the shared resource. For example, if no entities with budget remaining are requesting access to the shared resource, arbiter 110 might grant access requests from other entities that had exhausted their budgets but nonetheless continued to request access to the shared resource. In one embodiment, the request by one entity that had exhausted its budget may be charged against another entity that has excess budget remaining during that arbitration window. In another embodiment, the soft partitioning scheme may be implemented using the relative preferences of requesting entities. For example, a requesting entity may be given lowest priority once it has exhausted its budget in a given iteration of an arbitration window, and thereafter, requests by that entity would only be granted in the absence of requests from a higher priority entity—i.e., any other entity with budget remaining.

Registers 306 of the arbiter 110 may be accessible to software running on one of the cores 106, for example accessible to the boot software or operating system of the master core of a system. In one embodiment, at the beginning of the execution of a program, the operating system of the master core sends instructions to arbiter 110 with initial values for registers 306, values that may reflect both the needs of that program and the configuration of the system. In an alernate embodiment there may not be a particular core that is a master, but there may be a master thread executing one one or more cores, and that master thread may have the capability of writing to the arbiter registers, regardless of the core or cores on which is is currently executing.

Arbiter 110 then receives the instruction through communication interface 302. Control logic 304 takes the values from the instructions and writes those values into registers 306. Additionally, registers 306 may be rewriteable, even during the execution of a program. Therefore, a master core may cause arbiter 110 to switch between different arbitration schemes for different execution frames of a program. Alternatively, the master core may cause arbiter 110 to dynamically adjust the arbitration scheme based on the real-time needs of the system. At any given time, however, the arbitration scheme implemented by the arbiter would be the scheme described by the values stored in the registers of arbiter 110.

Control logic 304 may implement a cache accounting policy that takes into account cache coherency mechanisms implemented across the multiple cores. For instance, memory transactions triggered by cache coherency mechanisms may be charged to the budget of the requesting core. As an example, Core 1 may request access to an address in main memory that Core 2 has cached. If Core 2's cache is a write-back cache and the data has been modified, the cached value would be more current than the value residing in main memory at that address. Therefore, to ensure that Core 1 receives an accurate value from main memory, arbiter 110 may prioritize a memory write operation from Core 2's cache. The memory write, however, would be charged to core 1's time budget, rather than Core 2's budget, because the write operation resulted from processing on Core 1 not processing on Core 2. Depending upon the cache coherency mechanisms in place, arbiter 110 may otherwise prioritize and charge memory operations when appropriate.

The various requesting cores or entities need not be aware of the partitioning scheme of the arbiter or the current state of the budgets. Indeed, keeping the cores unaware of the arbitration scheme may facilitate changes in the arbitration scheme being implemented quickly and efficiently, without any propagation delay through the system. Without an awareness of its budget, a requesting entity may make a request when it has no budget remaining. The arbiter may refuse those access requests by entities without any budget remaining in a given arbitration window without any justification to the requesting entity. Alternatively, the arbiter may queue the requests from entities without remaining budget and fulfill those requests only once the arbitration window has been refreshed. Additionally, as discussed above with reference to the soft-partitioning embodiment, the arbiter may grant the request at the expense of another budgeted entity in the system.

Multiple shared resources in a system may be budgeted using the inventive system and methods. For example, each shared resource may have its own arbiter, and each arbiter may operate independently, implementing either the same or different arbitration schemes. As another example, multiple multi-core CPUs may be joined using high speed buses, and each set of cores may have its own local memory but may also retain access, across the high-speed buses, to the distant memory that is local to the other set of cores. Each bank of memory may have its own arbiter, and one possible arbitration scheme for such a system would give preference, for example through increased time budget or through request preference, to the local cores but would still budget some access time for the distant cores.

A variety of examples have been described above, all dealing with time partitioning of shared resources. However, those skilled in the art will understand that changes and modifications may be made to these examples without departing from the true scope and spirit of the present invention, which is defined by the claims. For example, the various units of the arbitration system may be consolidated into fewer units or divided into more units as necessary for a particular embodiment. Additionally, though this disclosure makes reference to shared memory, the inventive arbitration system and methods may be used with any other shared system resource or resources. Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

What is claimed is:

1. A system for time partitioning comprising:
a plurality of processing units;
a shared resource;
an arbiter disposed between the plurality of processing units and the shared resource, comprising:
a register containing a value corresponding to an arbitration window;
a set of budget registers containing values corresponding to a time budget for each processing unit; and
logic (i) to mark the beginning of an iteration of the arbitration window; (ii) to receive a request from a processing unit to access the shared resource; (iii) to determine whether the requesting processor has time budget remaining in the iteration of the arbitration window; (iv) to partition the shared resource in accordance with the determination; and (v) to replenish the time budgets of all of the processing units at the end of the iteration of the arbitration window.

2. The system of claim 1, wherein the arbiter further comprises logic (vi) to grant access to the shared resource by the requesting processing unit upon the determination that the requesting processing unit has time budget remaining in the iteration of the arbitration window; and (vii) to charge the request against the time budget of the requesting processing unit.

3. The system of claim 1, wherein the arbiter further comprises logic (vi) to refuse access to the shared resource by the requesting processing unit upon the determination that the requesting processing unit has no time budget remaining in the iteration of the arbitration window.

4. The system of claim 3, wherein the arbiter further comprises logic (v) to delay the request until the beginning of a next iteration of the arbitration window is marked; (vi) to grant access to the shared resource by the requesting processing unit; and (vii) to charge the request against the time budget of the requesting processing unit in the next iteration of the arbitration window.

5. The system of claim 1, wherein the arbiter further comprises an arbitration scheme register configured to select between a hard partitioning arbitration scheme and a soft partitioning arbitration scheme.

6. The system of claim 5, wherein when the arbitration scheme register is set to the hard partitioning arbitration scheme, the logic of the arbiter refuses access to the shared resource by the requesting processing unit upon determining that the requesting processing unit has no time budget remaining in the iteration of the arbitration window.

7. The system of claim 5, wherein when the arbitration scheme register is set to the soft partitioning arbitration scheme, the logic of the arbiter grants access to the shared resource by the requesting processing unit, upon determining both that the requesting processing unit has no time budget remaining in the iteration of the arbitration window and that no processing unit that has time budget remaining in the iteration of the arbitration window has a pending request to access the shared resource.

8. The system of claim 1, wherein the processing units may only access the shared resource through the arbiter.

9. The system of claim 1, wherein one processing unit has master status, and wherein the registers of the arbiter are accessible to the processing unit with master status such that the processing unit with master status can write values into the registers.

10. The system of claim 1, wherein the arbitration window value is in clock cycles, wherein the time budget values are in clock cycles, and wherein the sum of all values in the budget registers is not greater than the arbitration window value.

11. The system of claim 1, wherein the shared resource comprises a memory unit.

12. The system of claim 1, wherein the shared resource comprises an input/output bus.

13. The system of claim 1, wherein the arbiter further comprises a set of priority registers containing values corresponding to the precedence of each processing unit, and wherein the logic of the arbiter, upon receiving one request for access to the shared resource from each of a first processing unit and a second processing unit, compares values in the priority registers to determine that the first processing unit has higher precedence than the second processing unit; and grants the request for access to the shared resource by the first processing unit before granting the request for access to the shared resource by the second processing unit.

14. The system of claim 1, wherein the processing units comprise a plurality of cores.

15. A method for time partitioning, comprising:
receiving a request from a processing unit to access a shared resource;
if the requesting processing unit has time budget remaining for a present arbitration window, granting access to the shared resource by the requesting processing unit and charging the access against the time budget of the requesting processing unit; and
replenishing the time budgets of all of the processing units at the end of the present arbitration window.

16. The method of claim 15, wherein the arbitration window value and the time budget values are in clock cycles, and wherein the sum of all of the time budget values is not greater than the arbitration window value.

17. The method of claim 15, further comprising:
selecting a hard partitioning arbitration scheme;
determining that the requesting processing unit has no time budget remaining for the present arbitration window; and
refusing access to the shared resource by the requesting processing unit.

18. The method of claim 15, further comprising:
selecting a soft partitioning arbitration scheme;
determining that the requesting processing unit has no time budget remaining for the present arbitration window;
determining that no processing unit that has time budget remaining has a pending request for access to the shared resource; and
granting access to the shared resource by the requesting processing unit.

19. The method of claim 15, wherein the request is a first request and wherein the requesting processing unit is a first processing unit, further comprising:
receiving a second request to access the shared resource from a second processing unit; and
prioritizing the first and second requests according to a precedence between the first processing unit and the second processing unit such that the request from the processing unit with the higher precedence is granted before the request from the processing unit with the lower precedence.

20. A method for time partitioning, comprising:
receiving a request from a first processing unit to access a shared resource;
upon determining that the request from the first processing unit resulted from an operation carried out by a second processing unit and that the second processing unit has time budget remaining for a present arbitration window, granting access to the shared resource by the first processing unit and charging the access against the time budget of the second processing unit; and
replenishing the time budgets of all of the processing units at the end of the present arbitration window.
